(19) United States
(12) Patent Application Publication
(10) Pub. No.: US 2003/0150308 A1
(43) Pub. Date: Aug. 14, 2003

(54) Blade for cutting copper foil

(76) Inventors: Satoru Fujita, Saitama (JP); Masafumi Kinoshita, Saitama (JP); Naotomi Takahashi, Saitama (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/258,618

(22) PCT Filed: Mar. 20, 2002
(86) PCT No.: PCT/JP02/02651

(30) Foreign Application Priority Data
Mar. 23, 2001 (JP) 2001-86249

(51) Int. Cl. B26D 1/24; B21K 5/12

(52) U.S. Cl. 83/425; 83/495; 30/350; 76/116; 76/115

(57) ABSTRACT

An object of the invention is to provide a blade for cutting a copper foil being capable of further decreasing the amount of slivers generated at the time of processing, e.g., cutting, punching, and perforating a copper foil and also capable of making the size of the slivers smaller. To achieve the purpose, a disk-like blade to be employed for a copper foil-slitting apparatus is coated with diamond-like carbon (DLC) or diamond-like carbon soft (DLC-soft) on at least a part to be brought into contact with a copper foil at the time of cutting. The coating reduces the unevenness of a blade surface, thereby providing a face being scarcely scratched with the copper foil. Subsequently, the amount of the slivers generated is remarkably decreased and the cutting property is improved.

### TECHNICAL FIELD OF THE INVENTION

The present invention relates to a blade for processing a copper foil.

### BACKGROUND ART

A copper foil has widely been employed as a material for printed circuit boards in electric and electronic products. The copper foil is generally utilized by being cut in a desired shape and size during a copper foil manufacturing process and a process of manufacturing products such as a printed circuit board. Further, during these processes, the copper foil is sometimes punched or perforated at predetermined positions. In the case of cutting the copper foil, a cutting apparatus called, for example, a slitter or a cutter is generally employed. If the copper foil is cut or punched, or the copper foil is perforated using such an apparatus, slivers are generated. The slivers are supposed to cause a short circuit in a circuit in some cases, for example, in the field of printed circuit boards. Consequently, it is required to suppress an amount of the slivers generated as much as possible at the time of cutting the copper foil. Hence, in order to decrease the amount of the slivers generated, a blade made of high speed steels (high speed tool steels) and cemented carbides has been employed.

Recently, in the field of printed circuit boards, circuit boards have tended to have further higher integration and densification. Along with the tendency, a copper foil for circuit boards has been required to be a foil which enables pitches between neighboring circuits to be narrowed. For such tendency, it is probable that even slivers with a size smaller than the slivers which have conventionally been supposed possibly to cause a short circuit become a cause of the short circuit. In other words, defective products attributed to adhesion of smaller slivers are probably increased, resulting in a decrease in the yield of the products. In order to prevent such a decrease in yield, it is necessary to reduce an amount of the slivers generated and at the same time to make the size of the slivers generated smaller.

The invention has been developed under such circumstances and aims to provide a blade for cutting a copper foil which is capable of further decreasing the amount of the slivers generated at the time of processing, e.g., cutting, punching, and perforating a copper foil and also capable of making the size of the slivers smaller.

### DISCLOSURE OF THE INVENTION

In order to solve such problems, the sliver generation state has been investigated by continuously cutting copper foils using several types of conventional blades to find that basically, the amount of the slivers generated is increased as the cutting duration becomes longer. However, until predetermined time (for example, about 24 hours) passed after the start of cutting, the amount of the slivers generated was gradually decreased in some examples. Investigations into this phenomenon made it clear that a part brought into contact with a copper foil at the time of cutting is abraded by cutting the copper foil and in the initial stage of the cutting, the part is made less uneven owing to abrasion and that supposedly results in a decrease in the amount of the slivers generated. It can be supposed that if unevenness becomes slight, the blade becomes difficult to be scratched by the copper foil and the amount of the slivers generated is decreased. Consequently, it is supposedly possible that the amount of the slivers generated can be suppressed from the beginning of the use if a blade which is subjected to the treatment similar to this abrasion is employed.

Hence, the inventors of the invention have enthusiastically investigated the relation between the surface state of the part of a blade brought into contact with a copper foil and the amount of the slivers generated. As a result, it has been found that means of coating the blade face with diamond-like carbon (sometimes referred simply as to DLC hereinafter) or diamond-like carbon soft (sometimes referred simply as to DLC-soft hereinafter) is effective as means of lessening the unevenness of the blade.

That is, the invention is a blade for processing a copper foil, which is a disk-like blade to be employed for a copper foil-slitting apparatus and coated with diamond-like carbon (DLC) or diamond-like carbon soft (DLC-soft) in at least a part to be brought into contact with a copper foil at the time of cutting.

If a sharpened part (at least the part to be brought into contact with a copper foil at the time of cutting) of the disk-like blade to be employed for a copper foil-slitting apparatus is coated with DLC or DLC-soft, the amount of the slivers generated is remarkably decreased and the cutting property is improved. The decrease in the amount of the slivers generated occurs supposedly because the coating provides a face being scarcely scratched with the copper foil. Further, using the blade according to the invention, as compared with a conventional blade, the amount of the slivers generated is especially decreased in the initial state of the use of the blade. This is supposedly because a smooth face with a smaller friction coefficient can be obtained by surface-finishing with the coating rather than by a grinding work such as polishing. Further, since the face with a smaller friction coefficient can be obtained by coating with the above-described ceramic such as DLC, it can be expected that generation of the friction heat is suppressed at the time of cutting and that the cutting property hardly alters. Moreover, the blade according to the invention has an effect to make the generated slivers smaller in size. In general, it is supposed that the slivers are generated owing to the scratching of the blade with the copper foil and if the scratching is eliminated, the size of the slivers is supposed to become smaller to the extent of the elimination. The pitches between neighboring circuits in a circuit board have been narrowed along with the recent tendency to the high densification of circuit boards and even further smaller slivers are thought to be possible to cause short circuit, and therefore, if the slivers to be generated are made small, it leads to a preferable consequence that occurrence of the short circuit can reliably be prevented. A CVD method (a chemical vapor deposition method) and a PVD method (a physical vapor deposition method) are applicable as the coating method.

As a copper foil-slitting apparatus for which a disk-like blade is employed, there is a copper foil-slitting apparatus, for example, for continuously cutting a copper foil web manufactured by a method, e.g., so-called a continuous electrodeposition method, into a predetermined width. As cutting means of this apparatus, for example, there are means employing one blade attached to a receiving roller to be brought into contact with a continuously fed copper foil and another disk-like blade to cut the copper foil in cooperation with the former blades. The disk-like blade enters into gaps formed in a roller along the former blade. In the cutting means having such blades, the receiving roller in which the former blade is installed and the other roller with the disk-like shape are rotated so as to continuously cut a copper foil.

A disk-like blade according to the invention can be employed also for a copper foil-cutting apparatus to further cut a copper foil cut in a predetermined width and a blade of a cutting tool to be used in the case of cutting a copper foil manually by a worker other than such a copper foil-slitting apparatus for continuously cutting a continuously fed copper foil web.

Incidentally, as described above, in the copper foil-slitting apparatus for continuously cutting a copper foil web, generally disk-like blades are employed and while the blades being rotated, the copper foil is cut. By doing so, the entire circumference of the disk-like blades can be utilized for cutting the copper foil, so that the abrasion of the blades hardly proceeds as compared with that in the case of using fixed blades and the blades advantageously have prolonged lives. On the other hand, if the blades are rotated, the blades are affected more with the unevenness of the part to be brought into contact with a copper foil, so that the slivers are easy to be generated, as compared with the case where the blades are not rotated. At that point, according to the invention, the coating of the disk-like blades with DLC or DLC-soft gives a smooth face and reduces the amount of the slivers generated. That is, if the disk-like blades to be employed while being rotated in a copper foil-slitting apparatus are coated with a coating as described above, disk-like blades with long lives and scarcely generating the slivers can be provided and it is extremely preferable.

Further, another invention is a blade for processing a copper foil, which is a blade to be employed for a copper foil-cutting apparatus, characterized in that in at least a part to be brought into contact with a copper foil at the time of cutting is coated with diamond-like carbon (DLC) or diamond-like carbon soft (DLC-soft).

If a sharpened part of the disk-like blade to be employed for a copper foil-cutting apparatus is coated with DLC or DLC-soft having an extremely smooth surface, as described before, the blade is hardly scratched by the copper foil at the time of cutting the copper foil, so that the amount of the slivers generated is remarkably decreased and the cutting property is improved. Further, the coating provides effects that the amount of the slivers generated is especially decreased at the beginning of the use of the blade as compared with that of a conventional blade and at the same time, that the slivers to be generated become smaller. Owing to such facts, the blade is suitable as a blade for cutting a copper foil for a circuit substrate in which pitches of neighboring circuits are narrow.

The copper foil-cutting apparatus (so-called a shear cutter) is to be employed in the case of cutting a copper foil web into sheets with a predetermined length and cutting sheets of copper foils in a predetermined size and as cutting means of the shear cutter. For example, there are means employing one blade attached to a linear edge part of a table on which a copper foil, an object to be cut, is set and another blade, a blade to cut the copper foil in cooperation with the former blade, which moves down from the upper side to the lower side toward the former one. Both blades have sharpened parts (the parts to be brought into contact with a copper foil at the time of cutting) extended approximately straightly and by moving the latter blade down, a copper foil is to be cut by cooperative functions of both blades. Incidentally, the blades according to the invention can be employed also for blades of a cutting tool to be used in case of shear-cutting a copper foil manually by a worker other than the utilization as both blades for such a shear cutter.

Further, another invention is a blade for processing a copper foil, which is a cylindrical blade to be employed for a copper foil-perforating apparatus (sometimes referred simply as to a perforating apparatus hereinafter) characterized in that at least a part to be brought into contact with a copper foil at the time of cutting is coated with diamond-like carbon (DLC) or diamond-like carbon soft (DLC-soft).

If a sharpened part of the blade (a blade for processing a copper foil and hereinafter, sometimes referred as to a punching blade) to be employed for a copper foil-perforating apparatus is coated with DLC or DLC-soft having an extremely smooth surface, the blade is hardly scratched by the copper foil at the time of cutting the copper foil, so that the amount of the slivers generated is remarkably decreased and the cutting property is improved. Further, the coating provides effects that the amount of the slivers generated is especially decreased at the beginning of the use of the blade as compared with that of a conventional blade and at the same time, that the slivers to be generated become smaller. Owing to such facts, the blade is suitable as a blade for perforating a copper foil for a circuit substrate in which pitches of neighboring circuits are narrow.

In the production process of a copper foil and the production process of a product for which a copper foil is used, holes such as holes to be employed for positioning the copper foil are sometimes formed in the copper foil itself and the punching blade for perforation according to the invention is to be used for a perforating apparatus to be employed in such a case. The perforating apparatus comprises a table on which a copper foil to be perforated is set and a head part to which the punching blade is attached. The head part is movable up and down relatively to the table and is provided with a rotatable holder to hold the punching blade. The holder is rotated by a driving means such as a motor to rotate the punching blade held by the holder. In the case of perforating a copper foil, while the punching blade being rotated, the head part is moved up toward the table to push the punching blade against the copper foil and perforate the copper foil.

The punching blade comprises a base part to be held by a hold and an edge part having the sharpened part for actually cutting a copper foil and, for example, those having a rod-like and circular outer shape are employed. The direction of the rotation axis is the longitudinal direction of the blade. The shape of the edge parts of some rod-like blades is, for example, tapered to be gradually narrow toward the tip. In those cases, the tips of the edge parts of the blades and the parts with the shape tapered to be narrow toward the tips are the sharpened parts (the parts to be brought into contact with a copper foil at the time of cutting). Consequently, when a punching blade in a rotating state is pushed to a copper foil, the copper foil is circularly punched and perforated by the sharpened part, the edge or the like of the blade. Incidentally, there are hollow or solid blades as the cylindrical blade and in the case of a hollow one, the sliver dust can be discharged out from the base side of the blade by utilizing the hollow part.

In the case of perforating a copper foil, if it is possible to perforate a plurality of copper foils at one time while the copper foils being stuck, that is preferable, since the efficiency of the perforating work is improved. However, if the number of the copper foils to be stuck is increased, the slivers generated at one time perforation increase. Regarding that point, by using the punching blade having the sharpened part coated with DLC or DLC-soft as the blade used for perforation processing, the amount of the slivers generated is significantly decreased, and a plurality of copper foils can thus be perforated at one time. That is, if a coating as described above is formed on a punching blade, a blade capable of efficiently perforating copper foils by carrying out perforation of a plurality of copper foils at one time can be provided and it is extremely preferable.

Incidentally, at least the coated part is preferably made of a high speed steel (a high speed tool steel) and a cemented carbide. Because these materials are excellent in balance of the hardness and the toughness to be used for cutting copper foils. They are also excellent in radiating property.

The thickness of the coating is preferably 0.5 to 1.0 μm. Because if the coating is made thicker than 1.0 μm, the blade becomes roundish and the cutting property (the cutting capability) is deteriorated. If the service life of the blade may be short, the coating thickness is not particularly restricted for the lower limit, yet if the initial thickness (the thickness on the completion of the coating work) of the coating is too thin, a coating with even thickness cannot be obtained and a stable cutting property cannot be obtained in some cases. In consideration of such points, the thickness of the coating is preferable to be 0.5 μm or thicker.

### BRIEF DESCRIPTION OF THE DRAWINGS

FIG. 1 is a perspective view showing a slitter of one embodiment;

FIG. 2 is an illustration showing a flow of a copper foil in a slitter;

FIG. 3 is a plane view showing a main portion of a cutting mechanism of a slitter;

FIG. 4 is a magnified figure showing an edge part of a blade of a slitter;

FIG. 5 shows graphs of the results of slitting (cutting) test;

FIG. 6 is a perspective view showing a main portion of a cutter;

FIG. 7 is a perspective view showing a main portion of a perforating apparatus;

FIG. 8 is a front view showing a punching blade for perforation; and

FIG. 9 is a cross-sectional view of a plane along the A-A line of FIG. 8.

### BEST MODE FOR CARRYING OUT THE INVENTION

Hereinafter, preferable embodiments of the invention will be described with the reference to the drawings.

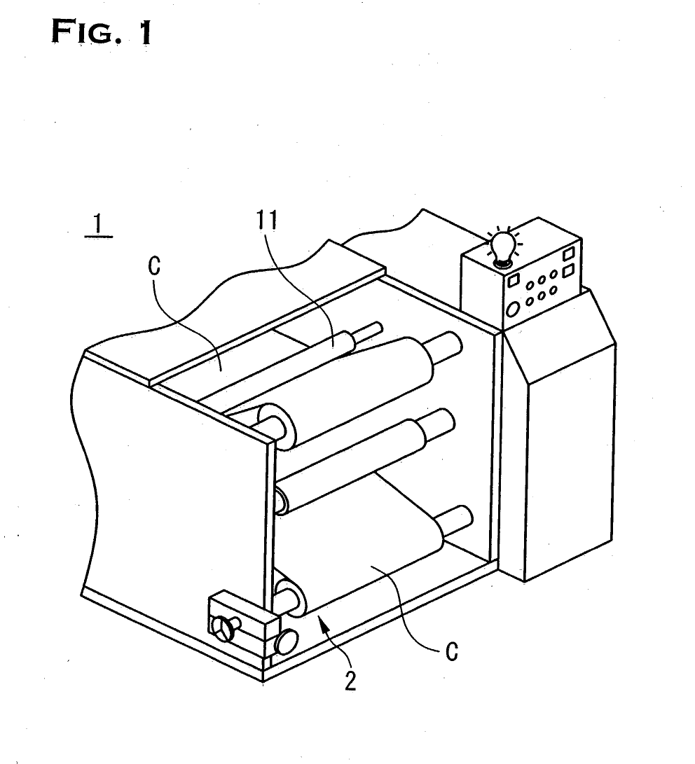

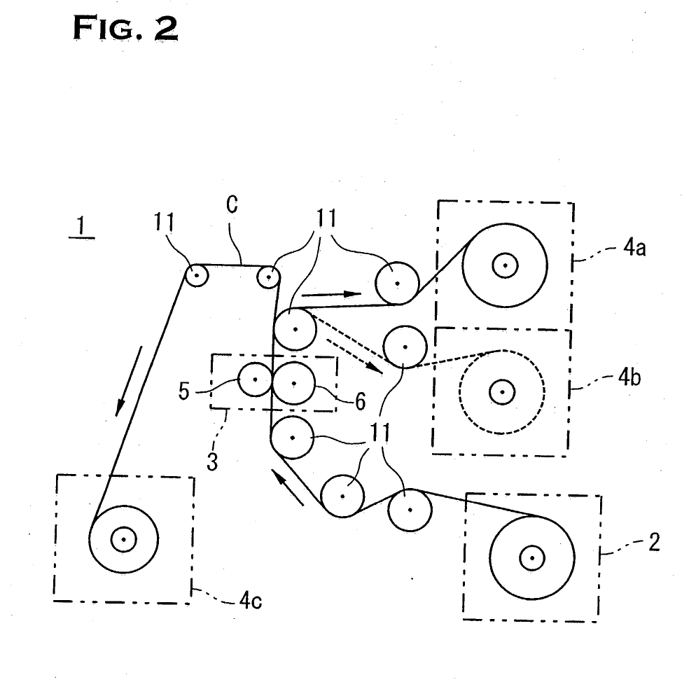

FIG. 1 illustrates a copper foil-slitting apparatus (referred simply as to a slitter hereinafter) 1 for cutting a copper foil using blades for copper foil processing according to the invention and FIG. 2 illustrates a flow of a copper foil C in the slitter 1. The slitter 1 is an apparatus for continuously cutting a copper foil web produced continuously by a continuous electrodeposition method or the like to a predetermined width and is provided with an unrolling mechanism 2 for supporting a roll on which a copper foil C before cutting is rolled, a cutting mechanism 3 provided with blades for cutting the copper foil C unrolled by the unrolling mechanism 2, rolling-up mechanisms 4a, 4b for rolling up the cut copper foil C, and a rolling-up mechanism 4c for rolling-up the cut part (ear). Further, the slitter 1 is also provided with rollers 11 in order to apply proper tension to the copper foil C or send the copper foil C unrolled by the unrolling mechanism 2 along with a predetermined path.

While being rolled in a roll-like state, the copper foil web C is transported to the unrolling mechanism 2, and after being unrolled by the unrolling mechanism 2, the copper foil web C is sent to the cutting mechanism 3 via a predetermined route by the roller 11 and cut in a predetermined width. The copper foil C cut in the predetermined width and the cut ear are sent separately to the respective rolling-up mechanisms 4a, 4b, 4c and rolled up. Incidentally, the mechanisms themselves for sending the copper foil C from the unrolling mechanism 2 to the rolling-up mechanisms 4 are those employed in a conventional slitter and their detailed description will therefore be omitted.

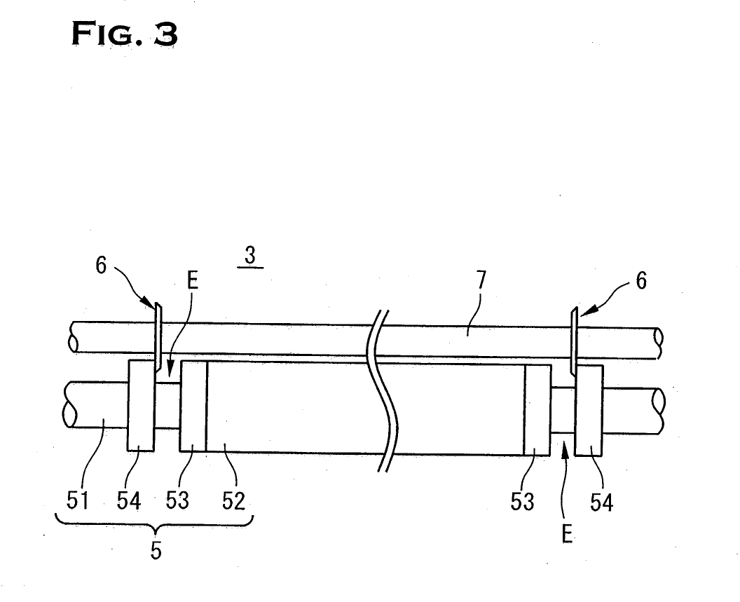

The cutting mechanism 3 comprises a receiving roller 5 to receive the copper foil web C continuously sent to the rolling-up side from the unrolling side and disk-like upper blades (blades for copper foil processing) 6 to be employed for cutting the copper foil C and continuously cuts the copper foil web C by cooperative functions (reference to FIG. 3) of the upper blades 6 and outside rings (lower blades) 54 attached to the receiving roller 5 as described later.

As being illustrated in FIG. 3, the receiving roller 5 comprises a cylindrical roller main body 51 supported in a manner of rotating around a rotation shaft extended in the width (longitudinal) direction and cylindrical body 52 attached to the outer circumference of the roller main body 51 in a detachable manner. The outer circumferential face of the cylindrical body 52 is specularly finished. A predetermined tension is applied to the continuously sent copper foil web C and the copper foil C is brought into contact with the outer circumferential face of the cylindrical body 52 in the whole width. Further, the receiving roller 5 is attached in a rotatable manner and at the time of cutting, the roller is so rotated as to keep the peripheral speed of the cylindrical body 52 in the outer circumferential face same as the sending speed of the copper foil C.

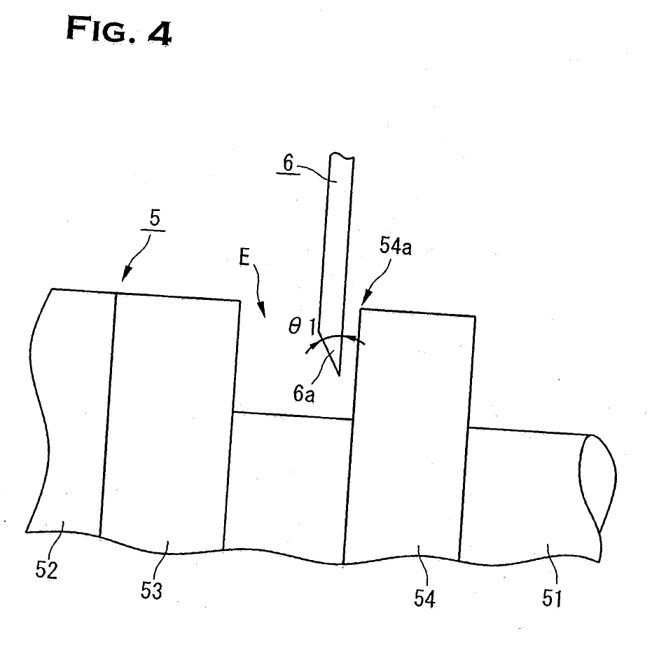

Among these components, circular inner rings 53 are installed in both sides of the cylindrical body 52 of the receiving roller 5 in the width direction and outer rings 54 are installed in the outside of the inner rings 53. Both outer rings 54 work as the lower blades to cut the copper foil C in cooperation with the upper blades 6. Further, a circular gap E is formed in the inside of each outer ring 54, that is, between the inside of each outer ring 54 and each inner ring 53. The sharpened parts (the parts to be brought into contact with the copper foil at the time of cutting) 6a of the upper blades 6 for cutting the copper foil in cooperation with each outer ring 54 at the time of cutting enter into each gap E (reference to FIG. 4). Incidentally, the cylindrical body 52 and rings 53, 54 are made detachable from the roller main body 51 and changeable. Consequently, the cutting width can be adjusted to be a predetermined size by installing a cylindrical body 52 and rings 53, 54 with proper size in the width direction.

Two existing upper blades 6 both are so-called rotary cutters with a disk-like shape and fixed in a shaft 7 extended in parallel to the receiving roller 5 in the longitudinal direction. The shaft 7 supporting the upper blades 6 is rotatable and so installed as to be moved close to and remote from the receiving roller 5, and by adjusting the position of the shaft 7 relative to the receiving roller 5, the entering distance of the upper blades 6 in the gaps E can be adjusted (reference to FIG. 4). Further, the upper blades 6 are made movable along the shaft 7. Consequently, in the case the positions of the outer rings (the lower blades) 54 are changed, the positions of the upper blades 6 can be changed accordingly.

In the case of cutting a copper foil C with a slitter 1 having such a cutting mechanism 3 in a predetermined width, rings 53, 54 corresponding to the width size are installed and at the same time, upper blades 6 are fixed at positions accordingly on the shaft 7. Further, the position of the shaft 7 is adjusted so as to properly adjust the entering distance of the sharpened parts 6a of the upper blades 6 in the gaps E and at the same time so as to properly adjust the distance of the gaps between the upper blades 6 and the outer rings (the lower blades) 54 by using an interval gauge. After both blades 6 and 54 are positioned and fixed in such a manner and when the copper foil C is sent to the rolling-up side from the unrolling side, the copper foil web C is continuously cut in a predetermined width by the cooperative functions of the upper blades 6 and the outer rings 54.

First embodiment: As the receiving roller 5 of a slitter 1, a roller with an outer diameter of 150 mm was employed. As the upper blades 6, those employed were blades each with a diameter of 120 mm, provided with a sharpened part 6a made of a high speed tool steel in the outer circumferential part, having an edge angle θ1 of 45°, and coated with a 1.0 μm-thick diamond-like carbon (DLC) in at least the sharpened part 6a. The outer rings 54 were made of a die steel (SKD-11) and their edges 54a (reference to FIG. 4) had an angle of 90°.

Second embodiment: As the upper blades 6, those employed were blades coated with a 0.6 μm-thick diamond-like carbon soft (DLC-soft) in at least the parts to be brought into contact with the copper foil C at the time of cutting. The conditions other than that were same as those of the slitter 1 of the first embodiment.

### COMPARATIVE EXAMPLE 1

As the upper blades 6, the blades made of a high speed steel (a high speed tool steel) were employed. The conditions other than that were same as those of the slitter 1 of the first embodiment.

### COMPARATIVE EXAMPLE 2

As the upper blades 6, the blades coated with a 0.6 μm-thick TiN (titanium nitride) in the sharpened parts (at least the parts to be brought into contact with the copper foil C at the time of cutting) were employed. The conditions other than that were same as those of the slitter 1 of the first embodiment.

### COMPARATIVE EXAMPLE 3

As the upper blades 4, the blades coated with a 0.6 μm-thick TiCN (titanium carbonitride) in at least the parts to be brought into contact with the copper foil C at the time of cutting were employed. The conditions other than that were same as those of the slitter 1 of the first embodiment.

### COMPARATIVE EXAMPLE 4

As the upper blades 6, the blades coated with a 0.6 μm-thick TiAlN (titanium aluminum nitride) in at least the parts to be brought into contact with the copper foil C at the time of cutting were employed. The conditions other than that were same as those of the slitter 1 of the first embodiment.

Using the slitters 1 of the respective embodiments and the respective comparative examples, copper foils and RCC copper foils (so-called resin-laminated copper foils) with a thickness of 35 μm were subjected to a test of continuously slitting (cutting) at 80 m/min speed. The tension applied to the copper foils at the time of cutting was 23 kg/m. In the test, the amount of the slivers generated and the size of the slivers was measured.

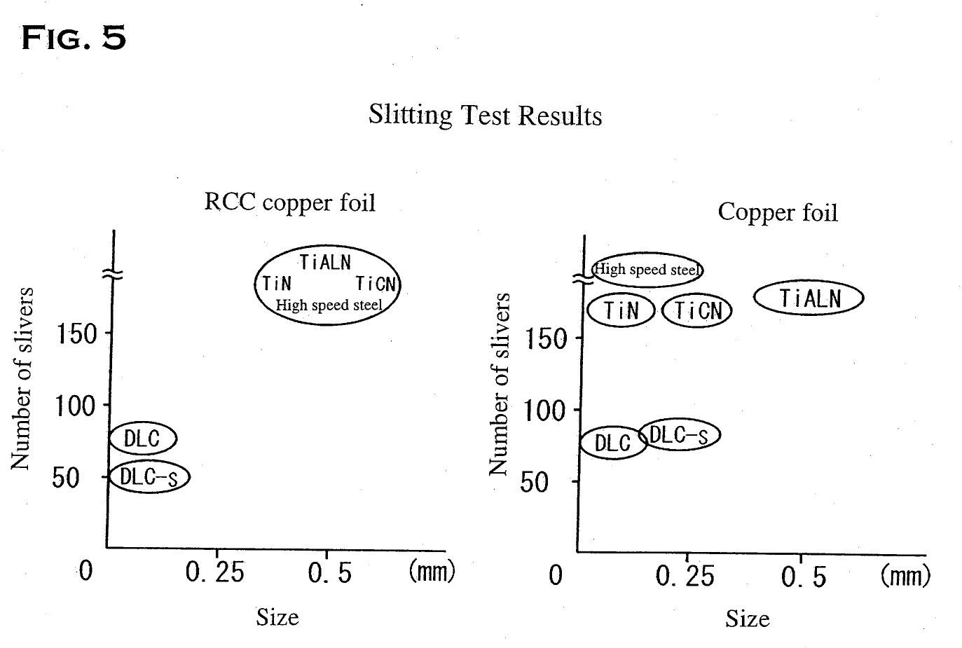

The number of the slivers was measured as follows. At first adhesive tapes were stuck along the cut cross-sections of the copper foils and later, they were peeled and the peeled tapes were observed by an optical microscope at ×100 magnification and the number of the slivers with about 0.01 mm or larger size was counted. The size of the slivers was judged by a gauge for size measurement in the lens of the microscope. After that, the number of the slivers per unit surface area was calculated by conversion calculation. Incidentally, a same tape was used as the adhesive tapes to make relative evaluation possible. The results of the test were shown in FIG. 5. Incidentally, the shown results of the test were the generation amounts of the slivers measured from 2 hours after the starting of the cutting to 48 hours after the starting (the number of the measurement times were 6) and the size of the slivers.

As being made understandable from the results of the test, the generation amounts of the slivers were found remarkably less in the embodiments than in the comparative examples regardless of the objects to be cut (slitted), copper foils or RCC copper foils. To explain more particularly, in the case of the embodiments, when either one of the copper foils was cut, the generation amounts of the slivers were 100/cm² or less. Meanwhile, in the case of the comparative examples 1 to 4, when either one of the copper foils was cut, the generation amounts of the slivers were 150/cm² or more.

On the other hand, regarding the size of the generated slivers, difference was observed in the results of the case of cutting the copper foils and of the case of cutting the RCC copper foils. When the copper foils were cut, the size of the slivers was 0.25 mm or smaller in the case of the embodiments and it was as large as about 0.5 mm in the case of the comparative examples, whereas, when the RCC copper foils were cut, the size of the slivers was around 0.5 mm in the case of the comparative example 4, however, in the cases other than that, the size of the slivers was as small as around 0.25 mm.

As a result, it was found that if those coated with DLC or DLC-soft were employed as the disk-like upper blades 6, the coating could provide effects that in the case of cutting the copper foils, the generation amounts of the slivers were significantly decreased and the size of the slivers became small. Moreover, the effects were stable regardless whether the copper foils, which were objects to be cut, were coated with resin or not.

Further, in the case the cutting test was continuously carried out, the alteration of the amounts of the slivers generated and of the size was measured. As a result, in the case of the slitters of the first and the second embodiments, even if the cutting duration lasted 24 hours or longer, no significant alteration was observed in the measurement results of the generation amounts of the slivers and the size. Contrary, in the case of the slitter of the comparative example 1, when the cutting duration lasted 24 hours or longer, the generation amounts of the slivers started increasing and when the cutting duration lasted 36 hours or longer, the average value of the size of the generated slivers started increasing. Then, as a result of the test continued further, the disk-like upper blades employed for the embodiments were found having the life (the service life) to be usable for cutting the copper foils at least three times as long as those of the disk-like upper blades of the comparative example 1 and having excellent durability.

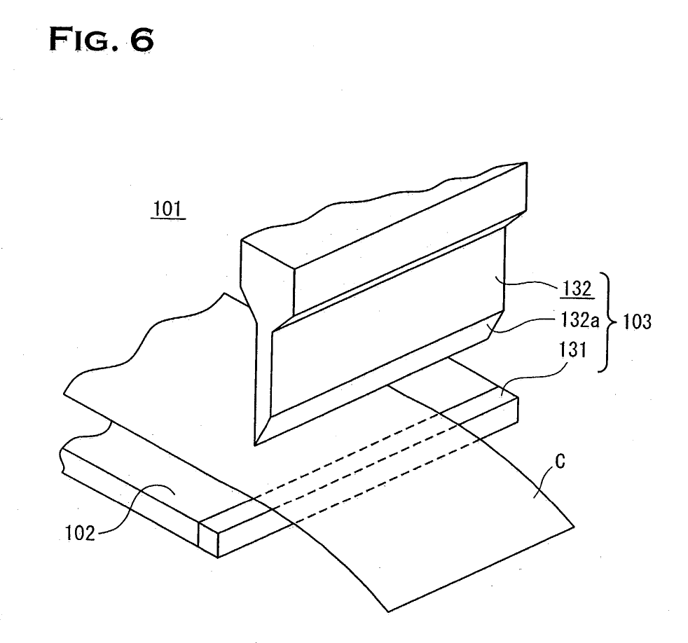

FIG. 6 shows the main portion of a copper foil-cutting apparatus (hereinafter, referred as to a cutter) 101 for cutting a copper foil by using a blade for copper foil processing according to the invention and the cutter 101 comprises an unrolling mechanism (not shown) for feeding a copper foil web C, an object to be cut, a table 102 for supporting the fed copper foil web C, and a cutting mechanism 103 set at the end of the table for cutting the fed copper foil C. In the cutter 101 with such a structure, the copper foil C was intermittently fed toward the cutting mechanism 103 from the unrolling mechanism and the copper foil C was cut. The length of the copper foil obtained by cutting can be determined by adjusting the one time feeding length. Incidentally, the unrolling mechanism and the cutting mechanism 103 are those employed for a conventional cutter and their detailed description will be omitted.

The cutting mechanism 103 comprises a linear lower blade 131 attached to the end part of the table 102 for supporting the copper foil C, an object to be cut, and a cutter blade (a blade for copper foil processing) 132 which is the other blade to cut the copper foil in cooperation with the lower blade 131 and made movable up and down relative to the lower blade 131. Then, when the cutter blade 132 is moved down toward the lower blade 131, the copper foil C is cut by cooperative functions of both blades.

Third embodiment: As the upper blade 132 of such a cutter 101, those coated with a 1.0 μm-thick diamond-like carbon (DLC) in the sharpened parts 132a were employed. As a result, results similarly good to those obtained in the case of coating the blades of the slitter 1 of the first embodiment were obtained.

Fourth embodiment: As the upper blade 132, those coated with a 0.6 μm-thick diamond-like carbon soft (DLC-soft) in the sharpened parts 132a were employed. The conditions other than that were same as those of the cutter of the third embodiment. As a result, results similarly good to those obtained in the case of coating the blades of the slitter 1 of the second embodiment were obtained.

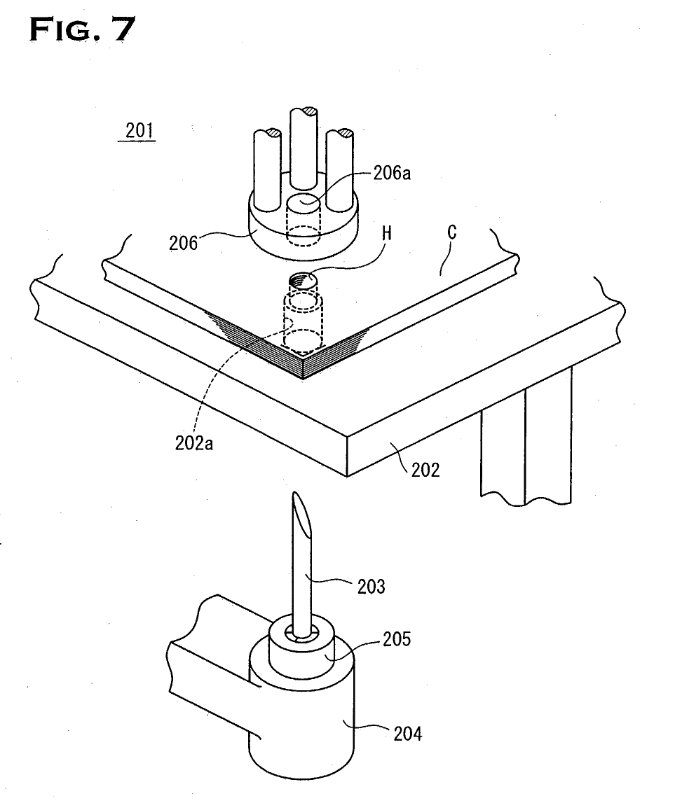

Further, FIG. 7 shows a perforating apparatus 201 for forming a hole H in a copper foil 1 cut in a predetermined size. The perforating apparatus 201 comprises a table 202 on which a copper foil C, an object to be perforated to form the hole H, is put and a head part 204 to which an approximately cylindrical punching blade (a blade of copper foil processing) 203 for forming a hole is attached. The head part 204 is attached to an apparatus main body (not illustrated) in up and down movable relative to the table 202. Further, the head part 204 is provided with a holder 205 to hold the punching blade 203. The holder 205 is attached to the head part 204 in a rotatable manner and rotated by a driving means (not illustrated) such as a motor or the like. In the case of forming the hole H in the copper foil C, the object copper foil C is at first put on the table and the copper foil C is positioned so as to put a predetermined position for perforation above the punching blade 203 and as the same time to push the copper foil from the upper side by a plate 206 and after that, while the holder 205 being rotated to keep the punching blade 203 rotating, the head part 203 is moved up toward the table 202 and the punching blade 203 is pushed to the copper foil C on the table 202 to form a hole H. Further, in the plate 206, a recessed part 206a in which a head of the punching blade 203 pushed to the copper foil C is inserted is formed to prevent the punching blade 203 pushed to the copper foil C from hitting the table. Incidentally, the table 202 of the perforating apparatus 201 and the head part 204 to attach the punching blade 203 thereto are similar to conventional ones and their detailed description will be omitted.

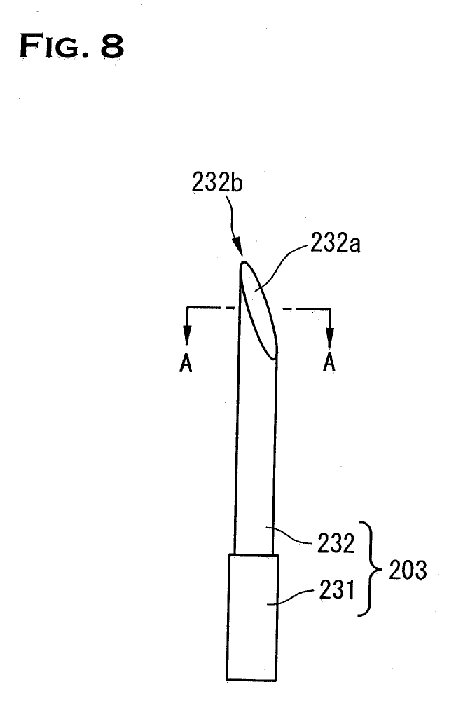

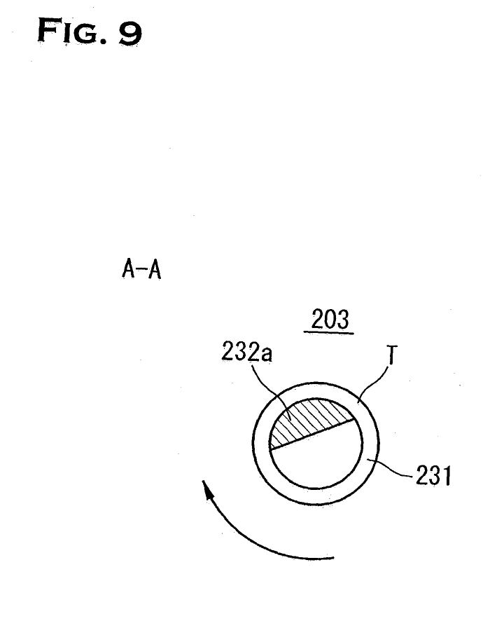

As illustrated in FIG. 8, the punching blade 203 for perforation has an outer appearance just like a rod-like cylindrical shape and composed of a base part 231 held by the holder 205 and the edge part 232 having the sharpened part (the part to be brought into contact with the copper foil at the time of cutting) to practically cut the copper foil C. To the holder 205, the punching blade 203 is so attached as to set the rotation axis in the longitudinal direction (reference to FIG. 7). The edge part 232 of the punching blade 203 has a tapered part 232a gradually narrowed toward the tip and the gradually tapered part 232a and the tip 232b of the edge part 232 are equivalent to the sharpened part. To explain more particularly the gradually tapered part 232a, as illustrated in FIG. 9, the punching blade 203 rotates in an arrow direction and the sharp tip part T of the punching blade 203 which is most projected forward in the rotation direction of the punching blade 203 in the tapered shape portion 232a and its peripheral part are the portion to be brought into contact with the copper foil at the time of cutting.

In the case of perforating the copper foil C, the punching blade 203 with such a shape is held in a holder (in the state illustrated in FIG. 7) and pushed to the copper foil C while being rotated. The tip 232b of the punching blade 203 is consequently pushed against the copper foil C. Since the tip 232b is rotated and moved in the circumference with a predetermined radius on the rotation axis, when the punching blade 203 is pushed, a circular hole H having a predetermined radius can be formed in the copper foil C. Further, the circular sliver dust generated by forming the hole H is removed by suction or the like. The punching blade 203 of this embodiment is so-called a solid blade, which is a blade not provided with a hollow part in the rotation axis part, and the sliver dust is removed from the side of the punching blade. Incidentally, in the case of so-called a hollow punching blade, which is a blade having the rotation axis part provided with a hollow part, the sliver dust can be discharged by utilizing the hollow part in the inside of the punching blade.

In the case of forming holes H in a plurality of sheets of copper foils C at one time as illustrated in FIG. 7, as described above, since the amount of the slivers generated by forming the holes H is increased as compared with that in the case of forming the hole H in one sheet of the copper foil C, in some cases, a work to remove the slivers is needed depending on the amount of the slivers and like this, the cutting work efficiency is probable to be decreased.

Fifth embodiment: Using the perforating apparatus 201, holes were formed in 100 sheets of 18 μm-thick copper foils at one time. As a punching blade 203, those made of a high speed steel, having a diameter of 6.4 mm, and coated with a 1.0 μm-thick diamond-like carbon (DLC) in the sharpened parts were employed. As a result, the results similarly good to those obtained in the case of coating the blades of the slitter 1 of the first embodiment were obtained.

Sixth embodiment: The punching blades coated with a 0.6 μm-thick diamond-like carbon soft (DLC-soft) in the sharpened parts were employed. Except that, the conditions were same as the perforating apparatus of the fifth embodiment. As a result, the results similarly good to those obtained in the case of coating the blades of the slitter 1 of the second embodiment were obtained.

### INDUSTRIAL APPLICABILITY

As described above, according to the invention, at the time of cutting a copper foil, generation of the slivers can be prevented. Consequently, adhesion of the slivers to a copper foil obtained after the processing such as cutting or the like can be prevented and the workability of the cutting work and the production yield of the products can be increased. The copper foil to which the adhesion of the slivers is prevented is suitable as a copper foil to be employed at the time of producing a highly dense circuit board.

1. A blade for processing a copper foil being a disk-like blade to be employed for a copper foil-slitting apparatus, characterized in that the blade is coated with diamond-like carbon (DLC) or diamond-like carbon soft (DLC-soft) in at least a part to be brought into contact with a copper foil at the time of cutting.

2. A blade for processing a copper foil being a blade to be employed for a copper foil-cutting apparatus, characterized in that the blade is coated with diamond-like carbon (DLC) or diamond-like carbon soft (DLC-soft) in at least a part to be brought into contact with a copper foil at the time of cutting.

3. A for processing a copper foil being a cylindrical blade to be employed for an apparatus perforating a copper foil, characterized in that the blade is coated with diamond-like carbon (DLC) or diamond-like carbon soft (DLC-soft) in at least a part to be brought into contact with a copper foil at the time of cutting.

4. The blade for processing a copper foil as claimed in any one of claims 1 to 3, characterized in that at least the coated part is made of a high speed steel or a cemented carbide.

5. The blade for processing a copper foil as claimed in any one of claims 1 to 4, characterized in that a thickness of the coating is 0.5 to 1.0 μm.
